(19) United States
(12) Patent Application Publication
(10) Pub. No.: US 2009/0055497 A1
(43) Pub. Date: Feb. 26, 2009

(54) METHOD AND SYSTEM FOR AUTOMATIC INSTANT MESSAGING DELEGATION

(76) Inventors: Scott Stephen Dickerson, Austin, TX (US); James Nichols Klazynski, Austin, TX (US); Tolga Oral, Arlington, MA (US)

Correspondence Address: IBM CORPORATION;C/O DARCELL WALKER, ATTORNEY AT LAW, P. O. Box 25048, HOUSTON, TX, 77265, US

(21) Appl. No.: 11/842,486

(22) Filed: Aug. 21, 2007

(51) Int. Cl. G06F 15/16

(52) U.S. Cl. 709/207

(57) ABSTRACT

An instant messaging system locates known delegates in its instant messaging list to which to automatically delegate messages based on whether an incoming message contains certain content. This method comprises the steps of simultaneously receiving multiple instant message requests at an instant message location. Initiating an instant message session with an alternate instant message resource device. After this initiation step, a handoff (transfer) message is generated to connect a received incoming instant message with the alternate instant message resource device. After the handoff, there is verification that the handoff has occurred. Those sending instant message questions could also get a quicker response to their question rather than waiting for one centralized person to manually delegate their question to a resource device.

### FIELD OF THE INVENTION

The present invention relates to a method and system for increasing the efficiency of a response to a transmitted instant message and in particular to an instant messaging method and system that determines the current capacity of a primary instant message recipient and automatically redirects a transmitted instant message to an alternate recipient when the a primary instant message recipient has reached its current message capacity.

### BACKGROUND OF THE INVENTION

Electronic mail (email) communications are an integral part of any business, and widely used outside of business as well. Although several new technologies currently compete with it, as the most ubiquitous tool in business communications, email remains one of the single most used communications tools for both the business and the personal user. Widespread availability, ease of use, and functionality are key components which hold email in front of developing communications methods; however, as new technologies compete for the top spot, email applications must continue to build upon the strong foundation currently in place to maintain their edge as the tool of choice. By any current standard, email applications would have to be rated as mature technology; however, if improvements in email applications cease to move forward, and other tools continue to improve, loss of market share will undoubtedly result.

E-mail has been the standard form of communication and information exchange. Telephone via the personal computer and shared collaboration are widely accepted and utilization of these modes are growing daily. Although E-mail is the main form of Internet communication, other new and popular forms of Internet communication, such as chat rooms and instant messaging (“IM”) have emerged.

Online chatting is a way of communicating by sending text messages in real-time to people in the same chat-room. The oldest form of true chat rooms are the text-based variety. The most popular of this kind is Intent Relay Chat (IRC). However, there are also talkers and havens. The popularity of these kinds of chat rooms have waned over the years, but IRC's popularity still remains strong. Also a notable number of people were introduced to chat rooms from AOL and web chat sites. The primary use of a chat room is to share information via text with a group of other users. New technology has enabled the use of file sharing and webcams to be included in some programs.

Instant messaging sessions (‘M’) are an emerging type of real time communication service. IM is somewhat like email, however, it should not be confused with a chat room. An instant messaging session is an “instant place” where two or more people can send text messages to each other. Both parties are online at the same time, and they “talk” to each other by typing these text messages and sending small pictures in instantaneous time. IM is based on instant messaging client programs that two separate people install, and those programs connect to send real-time typed messages to each other via an instant messaging service. This IM software allows a person to “talk” online with his/her friends in other rooms, other cities, and even other countries. The software uses the same cables and networks as any web page or email connection. As long as the other person has compatible IM software, IM works very well.

An instant messaging session starts when a person sends a text message to another person. This initial IM session is between two people. Other people can also join the instant messaging session. The current implementation of instant messaging sessions requires one of the session participants to invite the additional person to the session. The instant messaging session ends when the last user leaves the chat session.

Instant messaging is also becoming prevalent as a private extension to chat groups and is in use by over ten million people today. Instant messaging (IM) is an Internet protocol (IP)—based application that provides convenient communication between people using a variety of different device types. The most familiar today is computer-to-computer instant text messaging, but IM also can work with mobile devices, such as digital cellular phones, and can incorporate voice or video.

The millions of people using current Internet IM services and the growing popularity of short text messaging on mobile phones demonstrate that a market exists for IM services. Carriers can take advantage of this opportunity by offering advanced messaging services that integrate both fixed and mobile access and add new features that are not possible on free Web-based messaging services.

Because IM is a text-based service, instant messaging communication is generally not burdened by the need to transfer large graphic, sound, or program files. As a result, instant messaging is a relatively quick and easy to use system. In addition, instant messaging is widely available and its value as a means to access and retrieve data from a remotely located automated system is steadily increasing. One example of the expansion of instant messaging is a system, which interactively responds to and services requests from remotely located users. Such requests can include queries for general or specific information, requests to access and control various “WEB-enabled” devices, requests to store information for later use, reminder and paging services, as well as additional request-based functionality, such as suitable for use in various e-commerce environments.

Instant messaging allows end users to select “buddies” and assign these buddies to “buddy groups,” automatically register a person when on-line, advertise the user's selected buddies to the user when the selected buddies register on-line, advertise the user's presence on-line to others who have selected the user as a buddy, and participate in instant messaging communication between two on-line users. As mentioned, instant messaging has become a very popular form of communication. In addition, IM has become a basic tool that people use to conduct business. Many users create “buddy lists” using this instant messaging technology. These buddy names serve as point-to-point contacts for transmitting messages instead of entering a specific email address. Referring to FIG. 1, shown in a diagram of a typical communication network system over which an instant messaging buddy system can be implemented in accordance with the present invention. The network system includes a plurality of user stations 102 having a network link 104. The network link 104 is for receiving and transmitting data in analog or digital form over a communications network, such as the Internet. The communications network 100 connects each user station 102 as a “client” to a logon system 106, which is typically a software program executing on an instant messaging server on a network. Instant message servers can handle various aspects of the instant message transmissions. A primary function of the instant messaging server is to provide an awareness list of the potential message recipients to the sender clients. For instance if John is a messaging client and he has a list of 10 people in his buddy list, the buddy list will show John which of those 10 people is available and which are not, depending on the information stored in the messaging server. In addition, during the initial negotiation of the messaging session from a messaging client (sender) to a message recipient, the instant messaging server gives the sender client the contact details of how to contact the message recipient. Many Internet service related companies, i.e. Yahoo, AOL and Microsoft offer instant messaging services and have instant messaging servers to facilitate the services for their clients.

The logon system 106 communicates with a “Buddy List System” 108, which is preferably a software program executing on the IM server. The Buddy List System 108 maintains a database 110 for storing user information. The database 108 may be of any type, such as relational or hierarchical, and may be centralized or distributed. For example, the database 110 may be stored at least in part on each user's own station 102. In such a case, the database 110 contents would be transmitted to the Buddy List System 108 when the user logged into the system.

Instant messaging provides an extremely useful tool to increase productivity. In fact many corporations rely heavily on IM as part of their business process. In the customer service context, one-way client users contact merchant businesses via instant messaging. However, while instant messaging can be a valuable tool, IM can become overwhelming to the user when too many client requests come in at once to a single user. Currently, to delegate an incoming instant message to others, that is have another user handle the instant message, one can invite others to the chat session, type some message to perform the handoff (message transfer) and either leave the chat session or watch the window to insure that the request is being handled correctly. All of these processes are currently manual. Since hundreds of instant messaging delegations can occur per week, and they often occur for similar problems, some efficiency can be achieved by automating these delegations based on message content.

Other efforts have developed methods to improve instant messaging efficiency. Joyce et al. U.S. Publication No.: 20050111653 describes a method and apparatus is provided to process an instant message call within a customer interaction system. The method includes receiving the instant message call at the customer interaction system and processing the instant message call within the customer interaction system with other interaction types based on information associated with the instant message call. In general, embodiments described below feature a customer interaction system that receives and processes an instant message call with other interaction types based on information associated with the instant message call. In one embodiment, the instant message call is processed at a customer interaction system comprised of media specific customer interaction systems and a multimedia customer interaction system. The media specific customer interaction system associated with instant message calls receives and immediately forwards the instant message call to the multimedia customer interaction system for allocation to a live blended agent. In another embodiment, the instant message call is processed at the media specific customer interaction system without forwarding to the multimedia customer interaction system for allocation to a live agent. For example, the media specific customer interaction system associated with instant message calls would respond to an incoming instant message call by allocating an automated agent.

Neumann et al. in U.S. Pat. No. 6,744,761 describe a method and system for handling, that is routing and tracking, a plurality of incoming media streams of varying types—such as faxes, e-mail, Voice over IP.

Miloslavsky in U.S. Pat. No. 6,732,156 describes a system for routing electronic mails to one of a plurality of support persons in a processing center is disclosed. Each person has a skill set that is suitable for responding to a certain type of e-mail message. The system comprises an e-mail server for receiving the e-mail message from a sender, an information extractor for extracting relevant information from the e-mail, and a router for routing the e-mail. The router can make routing decisions and perform load-balancing and alert functions based on the information stored in the database and the server.

Although Miloslavsky does describe a method for routing e-mail messages, IM technology currently does not have the capability to forward an instant message sent that is sent to a recipient that is currently at their capacity with regard to the number of instant messages they can receive. Currently technology does not automatically forward newly received instant messages, but only sends a reply to the message sender stating that the recipient cannot receive messages at the present time. There remains a need for a method and system by which a primary recipient of an instance message can automatically designate an alternate location to receive and reply to an instant message when the primary IM recipient has reached their capacity to receive additional instant messages. The alternate location delegation can be based on a specific rule or a set or combination rules unique to that particular primary instant message recipient.

### SUMMARY OF THE INVENTION

The present invention provides a method and system to receive and delegate instant messages. A primary instant message resource location (a location that initially receives an incoming instant message) can define alternate instant message destinations to which the primary instant message resource device can automatically delegate a received instant message. The delegated location of the incoming instant message can be based on whether an incoming message contains certain content.

The method of this invention can initially generate a set of rules that will govern the delegating of instant messages from a primary instant message resource device to alternate instant message resource devices. These rules are stored in a primary instant messaging resource device. During operations, when an instant is received from a client at an instant messaging resource, there is a determination of whether the instant messaging resource is available to receive the incoming message. If the instant message resource is not available, then this method hands off or transfers the incoming instant message to an alternate instant message resource by inviting an alternate instant message resource to connect to the instant message where the client is currently connected. At this point, the instant message request from the client can be addressed by the alternate instant messaging resource.

The system of the present invention includes a communication network that connects an instant message request from a sender with a primary instant message recipient. The primary instant message recipient device contains a storage location with rules that govern the routing of certain instant message requests that are received at the primary instant message recipient. The instant message connection occurs in an instant messaging session between the sender and the primary message recipient. This system of the present invention also contains one or more alternate instant message recipients that receive certain instant messages from the primary instant message recipient when the primary instant message recipient simultaneously receives multiple instant messages.

A primary element of the present invention is that a potential delegation list for instant messages is stored and managed by each actual individual messaging recipient location. The recipient of the instant messaging request is really the one that best knows the expertise of the potential alternate recipients as compared to some centrally managed instant messaging administrator. Therefore, it is more efficient to track this knowledge distribution for each instant message recipient in each instant messaging recipients delegation list. The detailed description delegation (knowledgebase) for each instant message recipient is stored in a distributed knowledgebase, rather than a centrally server-stored knowledgebase.

### DESCRIPTION OF THE DRAWINGS

FIG. 1 is an illustration of a typical network for implementation of an instant messaging system.

FIG. 2 is an illustration of a network and instant messaging system for implementation of the present invention.

FIG. 3 is a flow diagram of the steps in the implementation of the method of the present invention.

FIG. 4 is an illustration of a configuration of a rules repository within an instant messaging resource in accordance with the present invention.

FIG. 5 is an illustration of a rules repository record in accordance with the present invention.

FIG. 6 is a detailed flow diagram of the steps in the implementation of the method of the present invention.

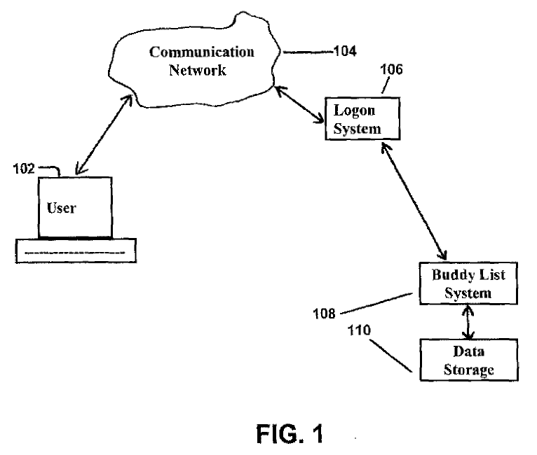

### DESCRIPTION OF THE INVENTION

The description of an implementation of the present invention will be in context of a customer service application. In such an application, client users (customers) contact the merchant representatives seeking assistance with user problems or issues. These contacts occur through instant message transmissions via computing devices at both the client user and merchant representative points. The computer device at the merchant representative contains the software that implements the method of the present invention.

The present invention detects when a situation exists where the number of requests being received at an instant message device for a merchant representative exceeds a predetermined threshold number of requests that the device can service at one time. In this invention, once there has been a determination that the number of instant message requests exceeds the threshold (more requests than ability to handle at an instant message resource) there is a transfer or routing of instant message requests to alternate instant message representatives. In the present invention, a rules engine is included in the instant messaging device/resource of the merchant representative to provide guidelines for where to forward instant messages in excess of the threshold number for that representative. Software also contained in the merchant representative's instant messaging resource can identify the content of an incoming message and apply filters (rules) to route the message when appropriate to a specific alternate instant message resource.

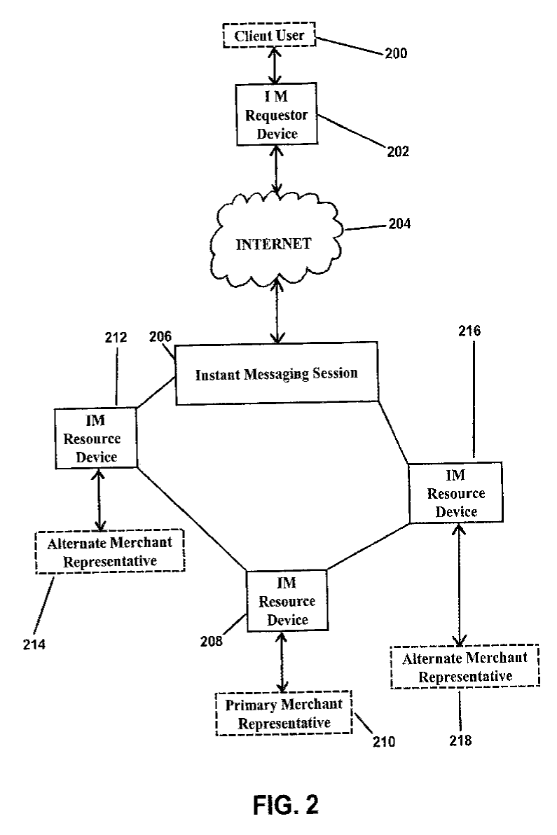

FIG. 2 is a configuration of an instant messaging system that can be used in the implementation of the present invention. This system comprises multiple computing devices that are capable of sending and receiving instant messages. A client user 200 has the capability to interact with the system of the invention by sending and receiving instant messages via a computing device 202 that has instant messaging capabilities. This computing device 202 could be a PDA commonly used in IM applications. In the implementation of the present invention, the instant messenge requestor device 202 communicates with other instant messenger devices via a communication network such as the Internet 204. The present invention can create instant messaging session 206 through an instant message server. This server 206 functions to establish the instant message session between a sender device 202 and a receiver device 208. Entities that provide instant messaging services have servers that facilitate this instant messaging service. The merchant representatives also interact with the method and system of the present invention through computing devices 208, 212 and 216. As mentioned, the initial communication within the present invention is between the instant messenger device 202 and the instant messenger resource 208. This IM resource device 208 has similar functionality to the PDA device of 202. However resource 208 contains additional storage capabilities for instant messaging designation rules and instant message designation software. In addition, the configuration of the present invention contains alternate instant messenger resource devices, 212 and 216 which are used by alternate merchant representatives. These alternate merchant representatives 214 and 218 serve as backup support in the event that the instant message device 208 for the merchant representative 210 receives multiple instant messages in excess of a predefined number simultaneously or at approximately the same time.

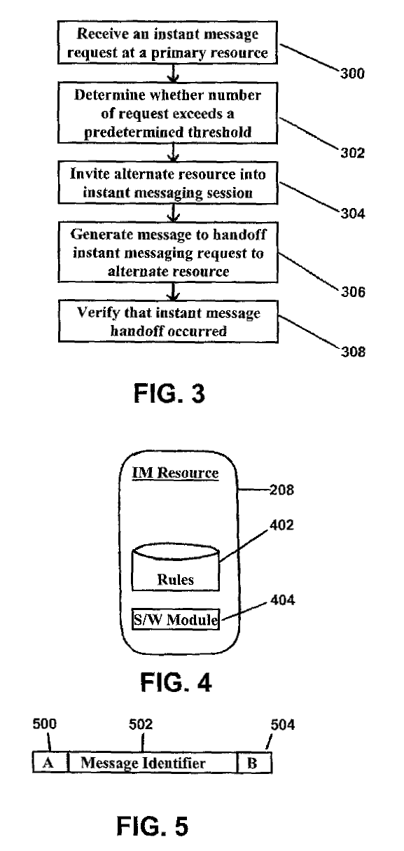

FIG. 3 shows the general steps in the implementation of the method of the present invention. In this method, a client user 200 employs instant messaging via device 202 to make a request of the merchant representative 210 via instant messenger resource device 208. In the business world, this request could be for some form of technical support. In step 300, the system of the present invention receives an instant message request. This instant message is received at IM device 208. Receipt of this message creates an instant message session between devices 202 and 208. This particular instant messaging session is directly between the user client user 200 making a request and the merchant representative 210. In the event the instant messenger resource device 208 receives multiple requests simultaneously or in close proximity to one another, step 302 will determine whether the current number of requests at device 208 exceeds a predetermined threshold number for that device. This determination could be through maintaining a current count of the number of instant message being serviced by that representative. For example, the number of current IM messages can be five messages. The threshold number can also be five messages. When a sixth message is detected, the determination would be that the number of received messages has exceeded the threshold number. In this case, step 304 will automatically invite an alternate resource into the instant message session to address the concern or issue of the user requester of the latest (6^{th}) received instant message. Once the alternate resource has been invited into the instant message session, step 306 generates a message to handoff (transfer) the instant message request from the user to the alternate resource. After the handoff has occurred, step 308 verifies that the transfer is complete. The alternate representative will then address the issue of the contained in the sixth message.

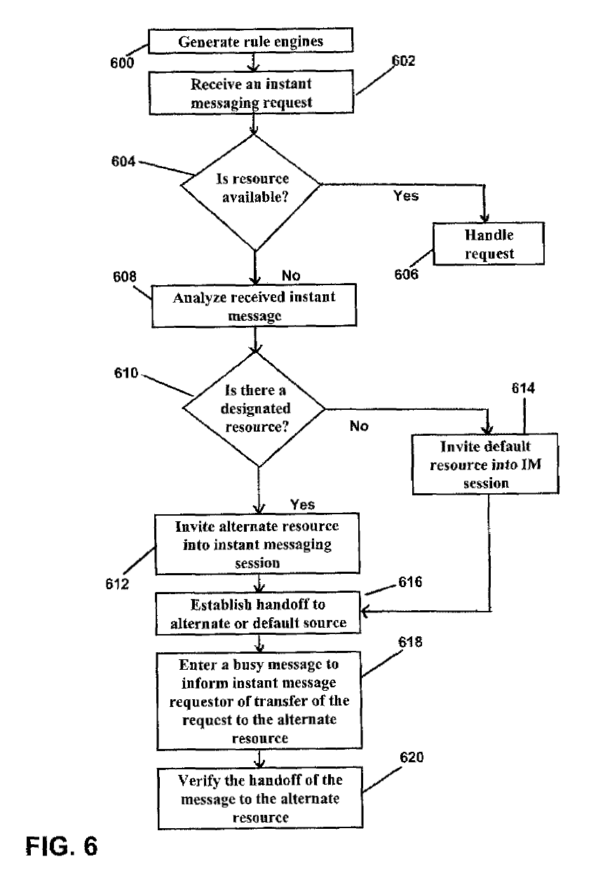

FIG. 4 illustrates an instant messaging resource (computing device) 208 used in the implementation of the present invention. As mentioned, stored in this device is a set of rules that govern the transferring of an instant message request to an alternate instant message resource. A rules repository 402 contains the rules that govern the transferring or forwarding of instant messages from the primary instant message resource 208 to alternate instant message resources 212 and 216. This rules repository could reside inside the instant message resource 208 or it could reside in a remote storage device that the instant message device can access. Another location for this repository could be the instant messaging server. This device also contains software that performs the message designation functions. The software module 404, which implements the method of the present invention described in FIGS. 3 and 6, can also reside in the computing device 208.

FIG. 5 is an illustration of a rules repository record in accordance with the present invention. As shown, each record can have multiple fields 500, 502 and 504. Each field can contain different types of information. One such field could be a rule identifier field 502. This field would contain information about the rule that can be used to determine which rules and filters apply to an instant message. The information in identifier field 502 can also be used to arrange the rules in the repository. The rules could be searched according to the content in this identifier field. The rules record can also have a field that contains the actual coded rule. Once a rule is identified from the content of field 502, the content of the rule could be read from a rule content field.

Each instant message could contain information describing the content of the message. The information could be included in a specific message field or header or in the main information content of the message. Key words or phrases can generally describe a problem encoutnered by a user or the general topic area of the message. Some examples of phrases can be ‘network failure’ or ‘slow system’. Since not everyone uses the same terminology to describe a situation, for some terms, incorporated in the software module 404 can be a process for associating a word with another word that has a similar meaning. A technique similar to the use of a thesaurus in word processing could implement this function. For example, if the user had a system that had stopped, the user may use the term ‘stopped’ in their instant message. The present invention would take the term ‘stopped’ and use it to identify a rule that may be related to a system stopping. However, the present invention can also use other words that have a similar meaning to ‘stopped’ such as ‘terminate’, ‘shutdown’, ‘close’ or ‘halt’ in the search for rules. Even though the sender used the term ‘stopped’ in the instant message, the rule search could produce a rule described as system termination that could be applicable to the request of the sender.

The method of the present invention can also generate and keep a history of message transactions and the proper routing location for these types of messages. The records could contain information about the source of an instant message, the destination of the message and the content of the message. These records can be generated and kept in the first IM representative device 208 as well as a second IM representative device 214. This historical information could be used to track the routing of certain types of messages and to generate new message transfer rules. If the historical data shows a certain pattern for responding to certain types of messages, then a rule could be created to cover that particular response.

FIG. 6 is a detailed flow diagram of the steps in the implementation of the method of the present invention. The initial step 600 in this method is to generate a set of rules that will govern the forwarding of instant messages. For example, if a merchant representative knew that they were always going to forward requests for WebSphere help to a known WebSphere expert, a filter rule can be defined like;

if content like % WebSphere and monitorChatWindow=true if currentChats>2 delegate to WebSphereExpert.

As mentioned, these rules could reside in the rules repository 402 for the merchant representative receiving the instant messaging request. After the completion of the generation of the rules repository, the method goes into a monitor mode waiting to receive an instant messaging request. The second step 602 is to receive that instant message request at the device 208 for the merchant representative. In a customer service environment, the instant message resource may be for a service or help contact. The instant messages for the merchant representative are received at the IM device 208. When the instant message is received at the merchant representative device, depending on the current activity of the instant message device, step 604 determines whether the device is available to receive another message. This determination could be based on the current number of instant messages that are being served through the IM device 208. If the determination is that the instant message device is available to receive other messages then the method moves to box 606 and that representative handles the request. If in step 604, the determination is that the number of messages at the IM device is currently at the determined threshold, then the method moves to step 608, which analyzes the received instant message. Even though the IM device has reached capacity, the incoming message is still received at the IM device. However, it will not be served at the device. In conventional systems, when a resource is at capacity, the message is not taken and the sender receives a busy or unavailable message.

This step of analyzing the instant message involves identifying information in the message and when appropriate, applying a generated rule based on the information in the message. This information in the message could include the identity of the source of the message and the message content. Based on information in the message, there would be an identification of the appropriate rule for that type of message request. The rule could contain the destination of alternate representatives. Step 610 can determine whether a particular rule applies to the incoming message and whether an identified rule designates a specific resource for a certain type of instant message.

In many cases, the rule could be to delegate the message to next available IM resource. This approach could be a default process when no rule applies to message content. However, the rules could also stipulate that messages with certain content would automatically transfer to certain representatives regardless of the load status of the device initially receiving the message. This approach would necessitate examining content of each reached message. If certain content were found, rules governing that specific content would apply to that message.

For example, there may be an alternate instant message resource called WebSphere Expert. In addition, an instant message is received with the content “Help my WebSphere box won't start”. At the same time, the instant message device would be at its threshold number and therefore would be too busy with existing instant messages to handle a new message. The method of the present invention would automatically identify the WebSphere Expert as the designated resource device in step 610. As mentioned, this identification would be based on one of the generated rules. If in step 610, the rules did not provide a designated alternate resource device, then there could be a designated default device to forward messages. The designation of the default resource device could be a rule in the repository. Another rule could be to designate a certain resource device based on the identity of the message sender.

When there has been a determination of the alternate resource device in step 610, step 612 would invite the alternate resource device into the instant messaging session. Step 614 would invite the default resource device into the instant messaging session. This default resource could be any alternate resource that is not at its' threshold number. In the present example, because WebSphere is identified in the message, step 612 would immediately invite the WebSphere Expert alternate resource into the instant messaging session. Step 616 would establish a handoff or transfer between the sender of the received instant message request and the alternate instant message resource device. Step 618 could inform the instant message requester of the handoff by entering a message saying, “Because the representative user is busy the instant message request has been delegated to WebSphere Expert” representative. In one preferred embodiment, the invention leaves the instant message window open so that a history is stored of how the request for help was handled. Step 620 would verify that the handoff of the message to the alternate resource device has occurred. In addition, notice that the automatic delegation above is activated depending on the currently active number of instant messaging sessions. For example, if 2 other instant messaging windows are currently occurring, this request will be delegated. If not, then the user will handle it directly.

The receipt of an incoming instant message at a resource device 208, the determination that the device has reached its threshold capacity and the decision to transfer the incoming instant message to another resource device 212 can be performed in a manner that is transparent to the representative of the resource device 208. The representative can receive a message informing them of the receipt and transfer of the message.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, poppy disc, hard disk drive, RAM, and CD-ROMs and transmission-type of media, such as digital and analog communications links.

We claim:

1. A method for automatically delegating an instant message received at a primary resource device to an alternate instant message resource device comprising the steps of:
generating a set of rules that governs the delegating of instant messages to alternate instant message resource device;
storing said generated rules in a primary instant messaging resource device, the generated rules will govern instant messages received at that particular instant messaging resource device where the rules reside;
detecting an incoming instant message at a primary instant message resource device;
determining whether the primary instant message resource device is available to service an incoming instant message request; and
transferring the detected incoming instant message to an alternate instant message resource device by inviting the alternate instant message resource device to connect to the received incoming message when there is a determination that the primary instant message resource device is not available.

2. The method as described in claim 1 wherein said transferring step further comprises the step of inviting an alternate instant message resource device into an instant messaging session with the primary instant message resource device and the instant message request.

3. The method as described in claim 1 further comprising after said transferring step, the steps of verifying the completion of the transfer and sending a message to inform an instant message requester of a transfer of the request to an alternate instant message resource device.

4. The method as described in claim 1 wherein said step for determining whether a primary instant message resource device is available to receive an incoming instant message request further comprises the step of determining whether the number of instant messages currently being served by the primary instant message resource device has reached an established threshold number of instant messages for that primary instant message resource device.

5. The method as described in claim 4 wherein said step of determining whether a primary instant message resource device is available to receive an incoming instant message request further comprise the steps of:
identifying a message descriptor from information contained in the instant message;
identifying a rule that is related to the information in contained in the instant message descriptor; and
applying the identified rule to determine an alternate instant message resource device.

6. The method as described in claim 4 wherein said step for determining whether a primary instant message resource device is available to receive an incoming instant message request further comprise the steps of:
identifying a message descriptor from information contained in the instant message;
determining whether there is a rule that is related to the information in contained in the instant message descriptor; and
applying a default rule to determine an alternate instant message resource device, when no rule relates the information contained in the message descriptor.

7. The method as described in claim 6 further comprising after said default rule applying step, the step of creating a new rule based on identified descriptors in the instant message and distributing the newly created rule to instant message devices.

8. The method as described in claim 1 further comprising after said transferring step, the step of recording information related to the transferred instant message.

9. The method as described in claim 8 further comprising the step of creating a history of message transactions, which include message descriptors, identity of message sender, and a transfer location of the message.

10. The method as described in claim 9 further comprising the step of generating rules that govern the delegation of instant messages received at a primary instant message location based on a prior message delegation history of messages received at a particular resource device and the messages having certain content in the message.

11. A system for automatically delegating an instant message to an alternate instant message resource device when a primary instant message resource device is busy comprising:
a primary instant message resource device for servicing instant message request;
a communication medium to facilitate communication between the user interface and the primary instant message primary resource device;
at least one alternate instant message resource device for servicing instant message requests when the primary instant message resource device is busy;
a rules repository that stores rules generated to determine the delegation of instant messages to alternate instant message resource devices; and
a software module to process instant message requests.

12. The system as described in claim 11 wherein said primary instant message resource device contains said rules repository as part of said primary instant message resource device.

13. The system as described in claim 11 wherein said a module to process instant message requests further comprises a software routine delegating instant messages received at the primary instant messaging resource device to alternate instant messaging resources devices

14. The system as described in claim 13 wherein said a module to process instant message requests further comprises a software routine for monitoring incoming instant messages, determining the current capacity of the primary instant messaging resource device and initiating an instant messaging session with an alternate instant messaging resource device when the determination is that the primary resource device has currently reached its capacity.

15. A computer program product stored in a computer readable storage medium for automatically delegating an instant message received at a primary resource device to an alternate instant message resource device comprising:
instructions generating a set of rules that governs the delegating of instant messages to alternate instant message resource devices;
instructions storing said generated rules in a primary instant messaging resource device, the generated rules will govern instant messages received at that particular instant message resource device where the rules reside;
instructions detecting an incoming instant message at a primary instant message resource device;
instructions determining whether the primary instant message resource device is available to service an incoming instant message request;
instructions transferring the detected incoming instant message to an alternate instant message resource device by inviting the alternate instant message resource device to connect to the received incoming message when there a determination that the primary instant message resource device is not available.

16. The computer program product as described in claim 15 wherein said transferring instructions further comprise instructions inviting an alternate instant message resource device into an instant messaging session with the primary instant message resource device and the instant message request.

17. The computer program product as described in claim 15 wherein said informing instructions further comprise instructions verifying the completion of the transfer and sending a message to inform an instant message requestor of a transfer of the request to an alternate instant message resource device.

18. The computer program product as described in claim 15 wherein said instructions for determining whether a primary instant message resource device is available to receive an incoming instant message request further comprise:
instructions determining whether the number of instant messages currently being served by the primary instant message resource device has reached an established threshold number of instant messages for that primary instant message resource device.

19. The computer program product as described in claim 18 wherein said instructions for determining whether a primary instant message resource device is available to receive an incoming instant message request further comprise:
instructions for identifying a message descriptor from information contained in the instant message;
instructions for identifying a rule relates to the information in contained in the instant message descriptor; and
instructions for applying the identified rule to determine an alternate instant message resource device.

20. The computer program product as described in claim 18 wherein said instructions for determining whether a primary instant message resource device is available to receive an incoming instant message request further comprise:
instructions for identifying a message descriptor from information contained in the instant message;
determining whether there is a rule that is related to the information in contained in the instant message descriptor; and
instructions for applying a default rule to determine an alternate instant message resource device when no rule relates to the information contained in the message descriptor.
